(19) United States
(12) Patent Application Publication
(10) Pub. No.: US 2009/0017193 A1
(43) Pub. Date: Jan. 15, 2009

(54) Method for Producing Series-Connected Solar Cells and Apparatus for Carrying Out the Method

(75) Inventor: Rainer Merz, Tamm (DE)

Correspondence Address: CENTRAL COAST PATENT AGENCY, INC, 3 HANGAR WAY SUITE D, WATSONVILLE, CA, 95076, US

(73) Assignee: UNIVERSITAT STUTTGART, Stuttgart (DE)

(21) Appl. No.: 12/162,301

(22) PCT Filed: Jan. 5, 2007
(86) PCT No.: PCT/EP07/00052

§ 371 Date: Jul. 25, 2008

(30) Foreign Application Priority Data
Jan. 27, 2006 (DE) 10 2006 004 869.5

(51) Int. Cl. B05D 5/12; B05C 13/00

(52) U.S. Cl. 427/74; 118/500

(57) ABSTRACT

The invention relates to a method and an apparatus for producing series-connected solar cells, wherein the method comprises the following steps: a substrate is introduced into at least one deposition chamber, at least one material layer is deposited on the substrate or a material layer which has already been applied in the deposition chamber, where in the substrate is applied to a bearing surface, which is curved in the direction of a depositing device, in the deposition chamber, wherein the substrate is flexible and is mechanically prestressed or is curved in a manner corresponding to the bearing surface and the applied layer is patterned using at least one tensioned wire which rests against the substrate, which has been applied to the curved bearing surface, with a defined force and shades the applied material layer or the substrate from the depositing device and thus patterns the material layer to be applied.

The invention relates to a method to produce series-connected solar cells, whereby the method includes a step to insert a substrate into at least one deposition chamber, and a step to precipitate at least one material layer onto the substrate, or onto a material layer already applied in the deposition chamber.

Thin-layer solar cells, particularly but not exclusively those based on amorphous Silicon, consist of a series of individual layers, namely a substrate and a rear-contact mounted on it; an active layer including any potential buffer layers or other necessary layers; and a front contact layer. The individual layers are pattern-structured as necessary for example using a laser or mechanical means after each layer is applied in order to maintain the distinction of individual layers, and the next layer is then applied. The subsequent layer must also then be structured. In this manner, a subsequent structuring process follows for each precipitated layer.

Along with the necessary additional process expense, the structuring processes possess various disadvantages. Structuring by means of mechanical scratching means may lead to formation of chips or cracks in the layer. Chips that are not flush may in turn create resistance to the cell, or short circuits between the front and rear contact layers may arise.

Structuring methods using a laser may cause individual layers to melt together because of the heat. Such meltings may lead to short circuits at the cut edges, or to parallel resistances between the front and rear contact layers. Further, it is known that serial-connected solar cells are produced in a simple manner in that the cells including the substrates are separated and subsequently a new connection of the front contacts with the rear contacts of the subsequent cell by means of overlapping adhesion using an electrically-conducting adhesive or by soldering. In this structuring method, the substrate must also be conductive. Depending on the quality of the adhesive and the adhesion additional resistance may result.

Moreover, the above-mentioned methods are only conditionally suited to continuous or quasi-continuous production. Particularly, the individual layers must be structured before the subsequent layer is precipitated. Upon interruption of the precipitation sequence, the hazard arises that the individual layers at the surface will react with ambient air.

DE 196 51 655 C2 reveals another method to structure connected solar cells, particularly serial-connected thin-layer solar modules, in which provision is made that at least the first semi-conductor layers of adjacent cells in their joining area become a common section that consists of the converted materials isolated from the first semi-conductor layers.

Such a configuration, and particularly connection in this manner, is not suited for continuous or quasi-continuous production.

Continuous or quasi-continuous methods to produce solar cells are known from U.S. patent documents U.S. Pat. No. 4,677,738 and U.S. Pat. No. 6,258,408 B1.

Starting with the State of the Art, it is the task of the invention to provide a method and apparatus of integrated connected solar cell modules that avoids the electrical disadvantages of previous methods while simultaneously providing a simple production method.

The invention solves this task by means of a method in which the substrate is applied within the deposition chamber onto a deposit surface that is arched in the direction of a precipitation device whereby the substrate is under mechanical tension or otherwise arched corresponding to the deposit surface, and structuring of the applied layer occurs as the result of tensioned wires that rest against the substrate applied to the deposit surface, and that shade the material layers already applied, or the substrate, thus structuring the material layer to be applied.

The substrate may be, for example, a flexible substrate that rests against a bent plane that is bent along the direction of a precipitation device. The wires rest simultaneously on these bent deposit surfaces between substrate and precipitation device, whereby a pre-defined force may be applied to the substrate by these tensioned wires while simultaneously providing a positive support over a pre-determined structuring area. The arched surface is thus preferably formed symmetrically about a central axis, and is particularly positioned in the precipitation area.

Alternatively, the substrate may be pre-arched per the arch of the deposit surface. In such case, metallic substrates may also be used.

Through the arch-shaped deposit of the substrate foil and the thus definable force setting along with the routing of the wires by means of which they rest on the deposit surface, a structuring is achieved on the layer below because of the shadowing effect. In this manner one may avoid material from ending up under the wires. When the layer is applied, the wires cause a shadowing effect on the material track, or the substrate, below it. It is particularly advantageous in this step that no separate structuring step must be provided. Structuring occurs at the same time as precipitation in a single process. The layers are thus subjected to no mechanical or thermal influence or loads after their precipitation. Thus, a continuous and stationary, or perhaps quasi-continuous, process is made possible that allows low-cost production of solar modules on low-cost, light-weight, and flexible substrates.

The wires may thereby be extended along the arch direction, which is particularly advantageous. For stationary methods, the wires may, however, lie along any direction between 0° and 90° to the arch direction.

Omission of the subsequent mechanical and thermal treatment allows a solar cell to possess good electrical, optical, and mechanical characteristics. Parallel resistances between the front and rear contacts cannot be established. Frictional forces from the shadowing wires acting on the substrate prevent the occurrence of cross-resistances between the rear contacts of individual solar cells.

The Plasma Enhanced Chemical Vapor Deposition (PECVD) method may in particular be used to deposit the layers.

The process may be operated as a stationary process, or it may be continuous or quasi-continuous. For continuous or quasi-continuous operating mode, the movement direction of the substrate is also the tension direction of the tensioned wires. Thus, the wires align themselves automatically for the desired mode.

A continuous or quasi-continuous process also offers the advantage that a difference of only one-dimensional layer results from the continuous movement of the substrate through the deposition chamber. These layer differences result only across the width (crosswise to the tension direction). Along the tension direction, no layer differences result for constant precipitation parameters.

In the manner described above, production of integrated-connected thin-layer cells on one substrate is possible. Subsequent structuring steps to the vapor deposition phase may be omitted. The width of potential solar cells to be produced depends on the width of the deposition apparatus. The length of the potential substrate to be coated is not limited by the apparatus. The dimensions of the deposition chambers may be matched to the layer to be deposited.

According to a first advantageous embodiment example, it may be provided that the wire is guided over a tensioning device and, particularly for continuous production, is moved along or against the movement direction. In this manner, with out limiting the usability of the wire, a covering of the wires with the deposited material from within the deposition zone may be achieved. Since the wires are wound out against the substrate movement, permanent new wire is then available on the layer to be deposited. The wire may thus subsequently be prepared mechanically or chemically for reuse, e.g., in an etching bath or by means of plasma cleaning.

It may thus be provided that the substrate is rolled and tensioned over guide rollers. Using such guide rollers, it is particularly simple to provide a good re-direction and simultaneous tensioning of a flexible material. Moreover, such methods are basically known to the State of the Art, whereby the winding out and winding up of the initial substrate and of the finished, coated substrate onto a take-up roller may result during a continuous production process.

It may also be provided that the wire is tensioned by means of a corresponding roller guide.

It is particularly advantageous for several deposition chambers to be positioned sequentially, whereby the substrate passes through deposition chambers in sequence, and a layer is deposited on the substrate or onto an existing layer and in each deposition chamber. For this, it may be provided that all, or merely one, of the additional deposition chambers is provided with a corresponding structuring device. Such in-line processes are particularly favorable during production.

The individual layers may thus be structured directly during creation, and may be deposited on top of one another in an in-line process. For this, it may be provided that the shadowing wires within the individual chambers are displaced with respect to the existing shadow lines in order to allow series connection.

In particular a foil or a textile material may be used as substrate.

Metal wires, or other plastic or textile fibers, carbon fibers, etc. may also be used for wire, whereby those materials to which the materials to be deposited do not adhere are in particular preferred.

Regarding the layers to be deposited, a front and a rear contact layer are specifically involved, along with an active layer that may in particular be formed between them using an n-layer, an i-layer, and a p-layer.

So-called staple cells, or tandem or triple cells, may also be used.

The active layer may consist of Silicon, or also Cadmium telluride, CIS, CIGS, etc.

Further, the invention includes an apparatus to perform the process of the type mentioned above, including at least one deposition chamber, whereby a coating device is positioned within the deposition chamber, and a structuring unit that includes at least wire for the structuring of the material layer to be deposited on a substrate while in the deposition chamber, whereby a support surface arched along the direction of a coating device is provided in the deposition chamber, and whereby the substrate is a flexible substrate formed under mechanical tension or is an arched surface matching the support surface, and the substrate to be laid onto the support surface and the wire may be rested against the support surface with pre-defined force at an angle of ≧0° and <90° to the arch direction.

Additional advantages and characteristics of the invention result from the remaining application documents, and from the following description of an embodiment example of the invention.

The figures show:

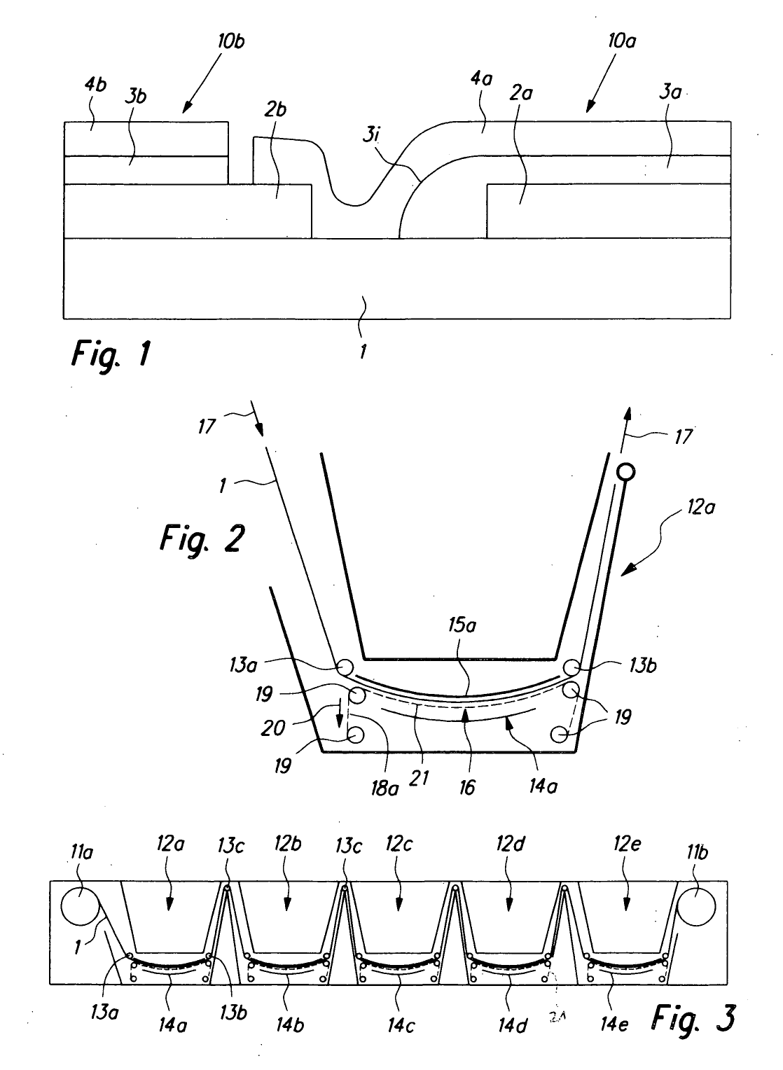

FIG. 1 a succession of layers of two integrated-connected thin-film solar cells;

FIG. 2 a device based on the invention; and

FIG. 3 a device and a method for continuous production of flexible thin-layer solar modules.

FIG. 1 shows a configuration of an integrated-connected solar cell that essentially includes a four-layer structure. Here the base of the solar cell is a flexible substrate layer 1, which may be formed using a foil or textile material. A so-called rear-contact layer is deposited onto this substrate layer which is preferably of three layers and whereby the layer sequence may be Chromium/Aluminum/Zinc oxide. Tin oxide or ITO may be used instead of Zinc oxide. The rear-contact layer must be so formed that it is not mounted directly onto the substrate, but rather that the rear-contact layers 2a and 2b of the various solar cells 10a and 10b that are to be connected together are separated from each other. For this, shadowing by means of wires is used in the invention resulting in a coating in separate sections crosswise to the transport direction, as will be described in the following. An active layer is now deposited onto this rear-contact layer that may in particular be formed of silicon. The layer contains p-n layers and insulating layers as necessary.

The active layer 3a or 3b of the various solar cell modules must therefore be separated from one another. Moreover, the active layer 3a and 3b must not cover the entire rear-contact layer. In the area in which the rear-contact layer 2b is facing toward the rear-contact layer 2a in order to subsequently allow contact by means of a front contact 4a, must not be covered by the active layer 3b. As the final layer, the front contact layer 4a is deposited such that it bridges the distance between the cells formed by the structuring between the rear contacts and the active layer, and creates an overlap with the rear-contact layer 2b of the next cell in order to allow serial connection of the solar cells 10a and 10b. The front contact layer 4 is thus transparent, and preferably consists of Zinc oxide (ZnO), Tin oxide (SnO2) or ITO.

Here it is important that the structuring of the rear-contact layer 2 occurs before the deposition of the active layer 3, since the active layer 3 simultaneously serves to separate and to insulate the rear-contact layer 2a from the front-contact layer 4a, whereby the active layer 3 in the area 3i extends to the substrate 1 in order to achieve all-sided insulation of both contact layers 2, 4 from each other.

FIG. 2 shows a corresponding method in a so-called roll-to-roll process. Here, the flexible substrate 1 is prepared on a supply roller 11a, as FIG. 3 shows, and is fed from this supply roller 11a into a first deposition chamber 12a. This first chamber, which is shown enlarged in FIG. 2, serves to deposit the rear-contact layer 2. The substrate 1 is thus pre-tensioned by means of rollers 13a and 13b, and stretched and fed across a support surface 15a to a deposition device 14a arched in the direction of a deposit device 14a. In the area of a deposition zone 16a that is limited by the area of the electrodes to deposit the layer material, said layer material for the rear-contact layer 2 is deposited onto the substrate. In order to perform the necessary structuring of the rear layer shown in FIG. 1, a wire guide 18a is provided parallel to the transport direction of substrate 1, as indicated by the arrow 17, by means of which the parallel-tensioned wires extending along the transport direction may be pressed onto the film of substrate 1 with pre-defined force, producing a shadowing effect under the wire, so that no material of the rear layer is deposited onto the substrate 1 under the wire in this area. Thus, depending on the quantity of solar cells 10 to be provided and passing crosswise to the transport direction, a proper number of wires 21 are provided that perform the shadowing, and thus separate the rear-contact layers 2 of individual solar cells 10 from one another.

Rollers 19 are thus provided to tension the wire 21 that perform re-direction and tensioning of the wire 21 as well as roll it up, since the wire is transported against the transport direction 17 in the direction of the arrow 20 in order to constantly present fresh wire 21 in the deposition zone on which no material deposits exist from the deposition of material onto the substrate 1. As soon as the wire 21 is used, new wire 21 may be made available, and the old wire 21 may be fed to a cleaning and recycling apparatus.

FIG. 3 shows a complete procedure to coat a substrate 1 that is provided from a supply roller 11a, and passes through a total of five chambers 12a through 12e, and subsequently is wound onto a take-up roller 11b. The take-up roller 11b thus contains completely integrated serial-connected solar cells 10. For this, the substrate 1 is tensioned and guided within each deposition chamber 12a through 12e via rollers 13a (positioned before the deposition zone) and 13b (positioned after the deposition zone). Additional rollers 13c may be provided for re-direction between the individual chambers. The entire procedure is thus a closed process that occurs in the absence of ambient air.

A deposition device 14a through 14e is positioned within each deposition chamber 12a through 12e, whereby a rear-contact layer is deposited in the first deposition chamber 12a, a n-layer is deposited in the second deposition chamber 12b, an i-layer is deposited in the third deposition chamber 12c, and a p-layer is deposited in the fourth deposition chamber 12d. The fifth chamber serves to provide the front-contact layer. Moreover, structuring is provided in each of the chambers 12. For this, the shadowing wires 21 must be displaced after the deposition of the rear-contact layer 2 with respect to those that are provided after the deposition of the semi-conductor layers 3 in order to ensure insulation of the rear-contact layer 2 by means of the active layers 3 with respect to the front-contact layer 4, and to ensure that no contact by the front-contact layer 4 of a solar cell 10a exists with the front-contact layer 4 of the adjacent solar cell 10b after the deposition of the front-contact layer 4. Only the shadowing wires 21 extend essentially without displacement during the deposition of the three layers forming the active layer in the deposition chambers 12b through 12d. A very small offset among these wires may be provided here. For this, the offset between the individual deposition chambers 12 is in the same direction, thus achieving series connection.

The symmetrically arched support surface 15a, which is arched along the direction of the deposition device, allows the wires that serve to provide the structure to be pointed in the desired direction, whereby this alignment is favored because of the friction between the substrate 1 and the arched surface 15, and cross-resistances between the rear-contact layers 2 is avoided.

In the manner described above, a so-called roll-to-roll process may be provided, or also a discontinuous procedure may be provided by means of which integrated-connected thin-layer solar cells may be produced.

1. Method to produce serial-connected solar cells, whereby the procedure includes the following steps:
Insertion of a substrate into at least one deposition chamber,
Deposition of at least one material layer onto the substrate or onto an existing material layer within the deposition chamber,
characterized in that
Within the deposition chamber, the substrate is deposited onto an support surface arched along the direction of a deposition device, whereby the substrate is flexible and is under mechanical tension, or is arched to match the support surface, and
Structuring of the deposited layer is performed by means of at least one tensioned wire that rests against the substrate applied to the arched support surface with a pre-defined force, and that shades the deposited material layer or the substrate from the deposition device, thus structuring the material layer to be deposited.

2. Method as in claim 1, characterized in that the procedure progresses continuously or quasi-continuously.

3. Method as in claim 1, characterized in that the wire is fed over a tensioning device and that in particular it is displaced along, or against, the transport direction during continuous or quasi-continuous production.

4. Method as in claim 1, characterized in that a minimum of one wire extends at an angle of ≧0° and <90° to an arch direction of the supporting surface.

5. Method as in claim 1, characterized in that the substrate is guided and tensioned over a roller assembly.

6. Method as in claim 1, characterized in that the wire is tensioned over a roller assembly.

7. Method as in claim 1, characterized in that several deposition chambers are arranged in sequence, and one layer is deposited in each chamber.

8. Method as in claim 1, characterized in that the substrate is formed of foil or textile-band material.

9. Method as in claim 1, characterized in that three layers, namely a rear-contact layer, an active layer, and a front-contact layer are deposited.

10. Method as in claim 9, characterized in that the active layer includes one or more charge-separating transition points, particularly pn- or pin-transitions.

11. Apparatus particularly to perform the procedure as in claim 1, including at least one deposition chamber (12), whereby a coating device (14) and a structuring unit (18) including at least one wire (13) are positioned within the deposition chamber (12), said wire being used to structure a material layer (2, 3, 4) to be deposited within the deposition chamber (12), whereby within the deposition chamber (12) a support surface (15) arched along the direction of the coating device (14), and whereby the substrate (1) is a flexible substrate (1) under mechanical tension, or is a substrate (1) arched to match the support surface (15), and the substrate (1) may be overlaid onto the support surface, and the wire (13) may be rested against the substrate (1) with pre-defined force at an angle of ≧0° and, <90° to an arch direction of the support surface (15).

12. Method as in claim 2, characterized in that the wire is fed over a tensioning device and that in particular it is displaced along, or against, the transport direction during continuous or quasi-continuous production.

13. Apparatus particularly to perform the procedure as in claim 10, including at least one deposition chamber (12), whereby a coating device (14) and a structuring unit (18) including at least one wire (13) are positioned within the deposition chamber (12), said wire being used to structure a material layer (2, 3, 4) to be deposited within the deposition chamber (12), whereby within the deposition chamber (12) a support surface (15) arched along the direction of the coating device (14), and whereby the substrate (1) is a flexible substrate (1) under mechanical tension, or is a substrate (1) arched to match the support surface (15), and the substrate (1) may be overlaid onto the support surface, and the wire (13) may be rested against the substrate (1) with pre-defined force at an angle of ≧0° and, <90° to an arch direction of the support surface (15).
